(19) United States
(12) Patent Application Publication
(10) Pub. No.: US 2016/0318377 A1
(43) Pub. Date: Nov. 3, 2016

(54) DEVICE FOR BLACKING-OUT A PICTURE WINDOW ACTUATED BY AN INFLATABLE ELEMENT

(71) Applicants: Aymeric PATIN, Marennes (FR); FLEXOMA, Marennes (FR)

(72) Inventor: Aymeric PATIN, Marennes (FR)

(21) Appl. No.: 14/897,327

(22) PCT Filed: Jun. 11, 2013
(86) PCT No.: PCT/FR2013/051362

§ 371 Date: Jul. 14, 2016

(51) Int. Cl. B60J 1/20; B60J 7/00

(52) U.S. Cl. CPC B60J 1/2091; B60J 7/0023

(57) ABSTRACT

A device for blacking-out a picture window (B), including a frame supporting a curtain which is mobile between a retracted position (R) and a black-out position (O) and includes at least one inflatable element built into the curtain and suitable for moving the curtain into the black-out position during the inflation thereof, and into the retracted position (R) during the deflation thereof.

### CROSS-REFERENCE TO RELATED APPLICATIONS

The present application is a National Stage of International Patent Application No. PCT/FR2013/051362, filed on Jun. 11, 2013 which is hereby expressly incorporated herein by reference in its entirety.

### BACKGROUND OF THE INVENTION

1. Field of the Invention

The present invention relates to the technical field of devices for blacking out a glazed opening of a vehicle used in particular for stopping at least part of the solar radiation passing through the glazing of the opening.

2. Description of the Related Art

In the above field, the use is known, in the context of motor vehicles in particular, of blackout blinds that are stored on a sprung wheel and are unwound manually in order to partially black out the glazed openings that they equip. Such systems have the drawback of not being able to be motorised easily.

Motorised curtains that move along rails integrated in the roof of the vehicle are also known for blacking out glazed roofs of vehicles. Such motorised curtains effectively allow remote control without manual manoeuvre but have the drawback of requiring systems for guiding and manoeuvring by cables that are complex and expensive as well as relatively heavy.

### SUMMARY OF THE INVENTION

The need has therefore appeared for a novel type of blackout device, which can be manoeuvred remotely in a simple and lightweight fashion without requiring a complex system for manoeuvring by cable.

In order to achieve this objective, the invention relates to a device for blacking out a glazed opening comprising a chassis supporting a curtain that is able to move between a retraction position and a blackout position and which comprises at least one inflatable element integrated in the curtain and suitable, when it is inflated, for moving the movable curtain into the blackout position and, when it is deflated, moving the movable curtain into the retracted position.

According to the invention, the inflatable element includes a flexible hollow envelope having:
a rear panel intended to be placed close to the glazed opening,
a front panel situated opposite to the rear panel and intended to be placed opposite the glazed opening.

A load bar is connected to the front and rear panels of the inflatable element, and a translational guidance mechanism of the load bar is moved in translation by the inflatable element between:
a folded position in which the curtain is folded in the retracted position, the load bar being close to the chassis, and
an unfolded position in which the curtain in unfolded in the blackout position, the load bar being distant from the chassis.

The use of an inflatable element associated with the load bar makes it possible to ensure the deployment and retraction of a curtain by translation movement in a simple manner without a control cable.

According to one feature of the invention, the blackout device includes at least one rigid rib that is connected to the front and/or rear panels of the inflatable element. The use of such a rigid rib makes it possible in particular to conform the inflatable element so that its rear panel has a shape complementary to that of the glazing of the opening. In addition, the rigid rib prevents the front and rear panels coming into contact with each other during deflation by aspiration of the air contained in the inflatable element. Each rigid rib may in addition include extensions ensuring the holding of the parts of the curtain that are not formed by the inflatable element or elements.

According to a variant of this feature, the blackout device includes a plurality of rigid ribs that are each connected to the front and/or rear panels of the inflatable element and are distant from each other when the curtain is in the blackout position. The distribution of the rigid ribs makes it possible to properly control the shape of the curtain in the blackout position as well as the deflation of each inflatable element. The rigid ribs are, preferably, substantially parallel to each other when the curtain moves in translation. However, another arrangement of the rigid ribs can be envisaged. Thus, when the curtain is deployed like a fan, the rigid ribs are disposed so as to converge in the same direction.

According to another variant of this feature, each rigid rib is situated inside the envelope of the inflatable element.

In the context of this variant, some rigid ribs at least may then comprise openings for the inflation air to pass.

According to another feature of the invention, some rigid ribs have, in transverse cross-section, a form at least partly convex and/or concave. Such a form of the ribs makes it possible to define a guidance space for the folds of the panels of the inflatable element in the retracted position without increasing the distance between the front and rear panels in the position of extension of the curtain when the inflatable element is inflated.

According to yet another feature of the invention, the inflatable element extends over the entire surface of the curtain. The use of such an inflatable element that extends over the entire surface of the curtain ensures better thermal insulation at the glazed opening.

According to the invention, the guidance mechanism may be implemented in any suitable manner. Thus, according to a first embodiment of the invention, the guidance mechanism includes at least one fixed bar for guiding the load bar. Such a fixed guide bar may then be situated outside the inflatable element. According to a variant of this embodiment, the fixed guide bar extends at least partly inside the inflatable element. The guide bar can then pass through the load bar and the envelope constituting the element without its being necessary to provide impermeability at this level. In this case, the inflation system has an inflation rate greater than the leakage rate at the place where the guide mechanism pass through the inflatable element.

According to a second embodiment of the invention, the mechanism includes comprise an articulated frame that is connected to the chassis, that carries, opposite to the chassis, a load bar connected to the curtain, and which is able to move between a folded position in which the curtain is in the retracted position, the load bar being close to the chassis, and an unfolded position in which the curtain is in the blackout position, the load bar being distant from the chassis.

The use of such an articulated frame facilitates the movements of the curtain between its blackout and retraction positions. Thus it is not necessary to use an external structure for guiding the curtain, which facilitates the installation thereof and therefore reduces the cost thereof.

According to another feature of the invention, the articulated frame is situated inside the envelope of the inflatable element. Such a positioning of the rigid frame protects it and conceals it from view in order to offer a satisfactory aesthetic appearance for the blackout device according to the invention.

According to yet another feature of the invention, each rigid rib comprises a passage window for the articulated frame.

According to one feature of the invention, the articulated frame is articulated on at least some of the rigid ribs.

According to another feature of the invention, at least some of the rigid ribs form an integral part of the articulated structure so that the articulated frame is at least partly formed by rigid ribs.

According to one feature of the invention, the blackout device comprises motorised inflator suitable for inflating and deflating the inflatable element.

Naturally the various features, variants and embodiments of the invention may be associated with one another in accordance with various combinations insofar as they are not incompatible with or exclusive of one another.

### BRIEF DESCRIPTION OF THE DRAWINGS

Moreover, various other features of the invention emerge from the accompanying description made with reference to the drawings, which illustrate non-limitative embodiments of a device, according to the invention, for blacking out a glazed opening.

FIG. 1 is a schematic cross-section in front view of a blackout device according to the invention in the retracted position.

FIG. 2 is a schematic cross-section in front view of the blackout device illustrated in FIG. 1 in the blackout position.

FIG. 3 is a schematic cross-section along the plane III-III in FIG. 2.

FIG. 4 is an elevation of a rigid rib constituting the blackout device illustrated in FIGS. 1 to 3.

FIG. 5 is a view similar to FIGS. 1 and 2 showing an intermediate phase of the movement of the blackout device.

FIG. 6 is a schematic perspective showing a variant embodiment of an articulated frame of a blackout device according to the invention.

FIG. 7 shows another embodiment of a blackout device according to the invention in side view.

FIG. 8 shows another embodiment of a blackout device according to the invention in front view.

FIG. 9 shows another embodiment of rigid ribs constituting a blackout device according to the invention.

FIG. 10 shows another embodiment of rigid ribs constituting a blackout device according to the invention.

FIG. 11 shows another embodiment of a blackout device according to the invention, in front view.

FIG. 12 shows another embodiment of a blackout device according to the invention, in front view.

FIG. 13 is a schematic cross-section of another variant embodiment of a blackout device according to the invention.

It should be noted that, in these figures, the structural and/or functional elements common to the various variants may have the same references.

### DETAILED DESCRIPTION OF THE INVENTION

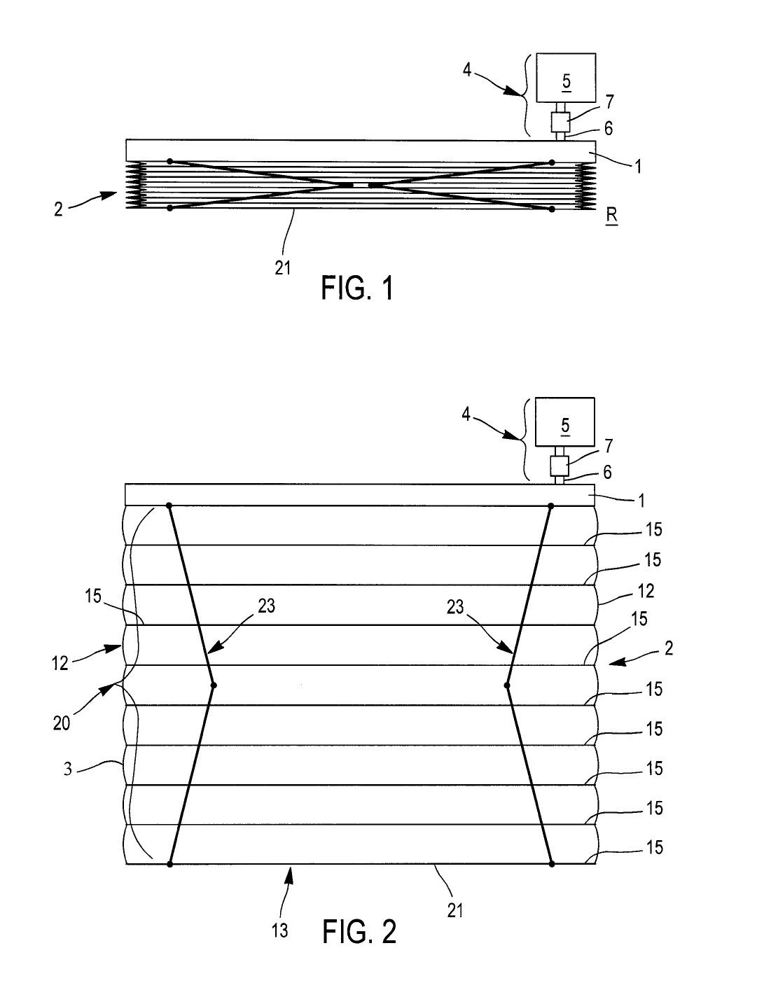

A blackout device according to the invention, as illustrated in FIGS. 1 to 3, is intended to provide temporary and at least partial blackout of a glazed opening B such as for example a side window of a vehicle, a windscreen or a rear window. It should be noted that, if the blackout device according to the invention finds a preferred application in the blacking-out of vehicle openings, it may also be used for blacking out glazed openings of buildings.

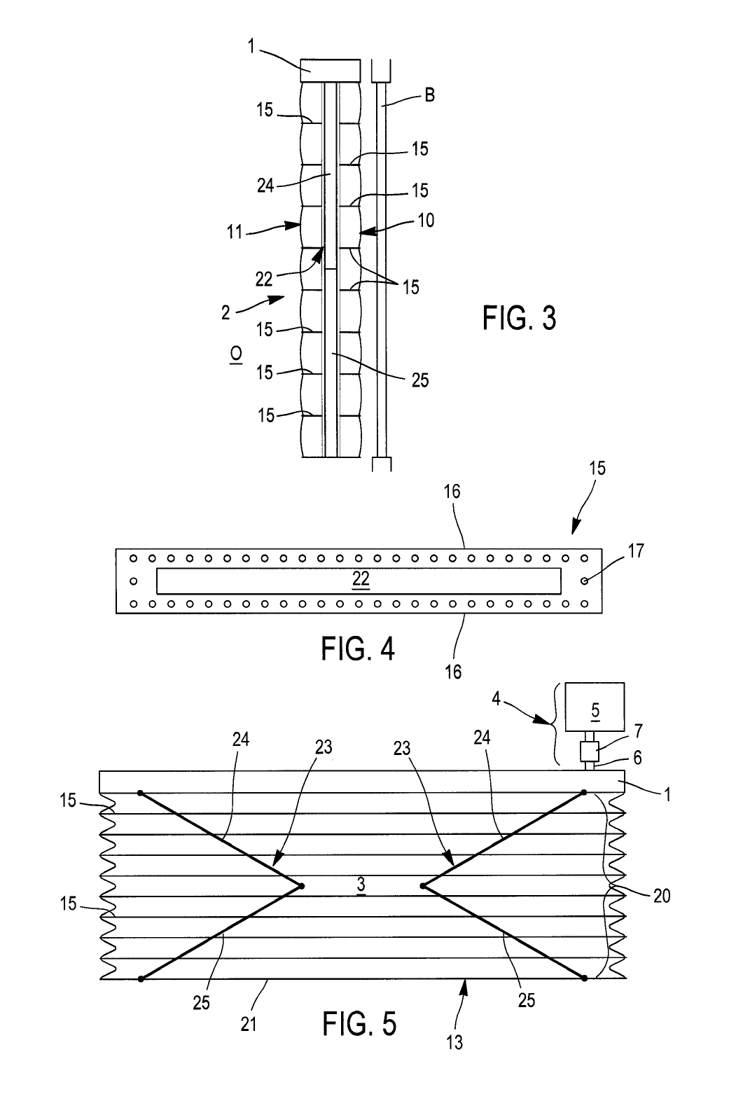

The blackout device comprises a chassis 1 that supports a curtain 2 able to move between a retracted position R, illustrated in FIG. 1, and a blackout position O that is shown in FIGS. 2 and 3 and in which the curtain 2 at least partly blacks out the opening B. The chassis 1 is intended to be integrated in the bearing structure of the opening, or to be attached to this bearing structure. The curtain 2 comprises at least one inflatable element 3 that is connected to inflator 4 suitable for blowing or aspirating air into the inflatable element 3. The latter is then suitable, when it is inflated, for moving the movable curtain 2 into the blackout position and, when it is deflated, moving the movable curtain into the retracted position R. The inflator 4 includes, for example, a reversible electric pump 5 that is connected by a pipe 6 to the inflatable element 3. The pipe 6 is then controlled by a valve 7 that is open when the pump 5 is functioning and closed when it is stopped. Thus, depending on the direction of operation of the pump 5, the inflator 4 provides the filling or emptying of air for the inflatable element 3. The pump 5 may be situated in the immediate vicinity of the chassis 1 or even be integrated in the chassis 1 or on the contrary be situated at a distance from the chassis 1 while being connected to the inflatable element 3 by the pipe 6.

According to the invention, the curtain 2 may comprise one or more inflatable elements occupying only part of its surface. According to the example illustrated, the inflatable element 3 extends over the entire surface of the curtain 2 so that the latter can overall be termed an inflatable curtain.

The inflatable element 3, constituting the curtain 2 in the present case, is formed by an envelope that comprises a rear panel 10 intended to be placed close to the glazed opening B and a front panel 11 situated opposite to the rear panel 10 and intended to be placed opposite to the glazed panel B. The inflatable element 3 also comprises two lateral panels 12 and a bottom panel 13 that connect the front 11 and rear 10 panels. The inflatable element is further connected, opposite to the bottom panel 13, sealingly to the chassis 1, which fulfils a function of distribution box providing a distribution of the air over the entire length of the chassis 1. The envelope constituting the inflatable element 3 may be produced from any suitable airtight material. Thus the envelope may be produced from a film of multilayer plastic material comprising a sheet of a reflective material such as aluminium so as to reflect part of the solar radiation in order to reduce the greenhouse effect inside the vehicle when the curtain 2 is in the blackout position O. Moreover, it should be noted that the inflatable character of the curtain 2 enables it to constitute an insulation element for the glazed opening B when it is in the blackout position. It should be noted that the airtightness of the envelope is not necessarily total and that it may have one or more leakage points.

According to the example illustrated, in order to facilitate deflation and prevent the inflatable element, once inflated, forming excessive bulges, the blackout device comprises at least one and, according to the example illustrated, eight rigid ribs 15 that are each connected to the front 11 and rear 10 panels of the inflatable element 3. Each rigid rib 15 has a substantially rectangular shape, as is clear from FIG. 4. Each rib 15 is formed by a flank of thin plastics material. The rigid ribs 15 are disposed inside the envelope 3 with their longitudinal edges 16 welded or adhesively bonded to the front 11 and rear 10 panels so that the ribs 15 define chambers inside the envelope 3. To allow a good circulation of air inside the inflatable element 3 and from one chamber to another, each rib 15 comprises openings 17 for the inflation air to pass. The rigid ribs 15 are disposed substantially parallel to one another while being distributed inside the envelope 3 when the curtain 2 is in the blackout position O.

The rigid ribs 15 therefore prevent the front 11 and rear 10 panels being too far away and forming bulges when the inflatable element 3 is inflated. In addition, the rigid ribs 15 prevent the front 11 and rear 10 panels sticking to each other under the effect of atmospheric pressure when the air is aspirated out of the inflatable element 3 in order to return the curtain 2 to the retracted position R. This is because such contact between the front 11 and rear 10 panels of the inflatable element 3 would be liable to form an obstacle to complete deflation thereof.

According to the example illustrated, the blackout device also includes, as guidance, an articulated frame 20 that is connected to the chassis 1. The articulated frame 20 carries, opposite to the chassis 1, a load bar 21 that is connected to the curtain 2 and more particularly to the front 11 and rear 10 panels at the bottom part of the latter. In the present case, the articulated frame 20 is disposed inside the inflatable element 3, passing through the apertures 22 formed for this purpose in each of the rigid ribs 15. The articulated frame 20 comprises two arms 23 formed by two segments 24, 25 articulated together. A first segment 24 is further articulated on the chassis 1 while the second segment 25 is articulated on the load bar 21.

The blackout device as thus formed functions as follows.

From the retracted position R as illustrated in FIG. 1, when deployment of the curtain 2 is required, the functioning of the pump 5 and the opening of the valve 7 are controlled so as to blow air inside the inflatable element 3. This inflation contributes to the erection of the inflatable element 3 so as to bring the curtain 2 into its blackout position O as illustrated in FIG. 2.

Once inflation has ended, the pump 5 is stopped and the closure of the valve 7 is demanded. Thus the inflatable element 3 remains in the inflated position and maintains the curtain 2 in its blackout state. Closure of the valve 7 prevents spontaneous deflation of the inflatable element 3, in particular when the articulated frame is returned to the folded position.

When retraction of the curtain 2 is required in order to leave a clear view through the glazed opening B, opening of the valve 7 and operation of the pump 5 in aspiration is demanded in order to discharge the air contained in the inflatable element 3. The negative pressure thus created in the inflatable element 3 tends to fold the panels thereof inwards as shown in FIG. 5, the rigid ribs 15 then making it possible to control this folding while preventing the panels from coming into contact with each other so that the air can be completely discharged inside the envelope by passing through the openings 15 and the apertures 22. In addition, the articulated frame that passes inside the apertures 22 prevents the rigid ribs 15 from being placed aslant so that the curtain 2 can fold gradually to its retracted position. In the retracted position the inflatable element and the curtain are therefore folded on themselves in a concertina like the bellows of such a concertina.

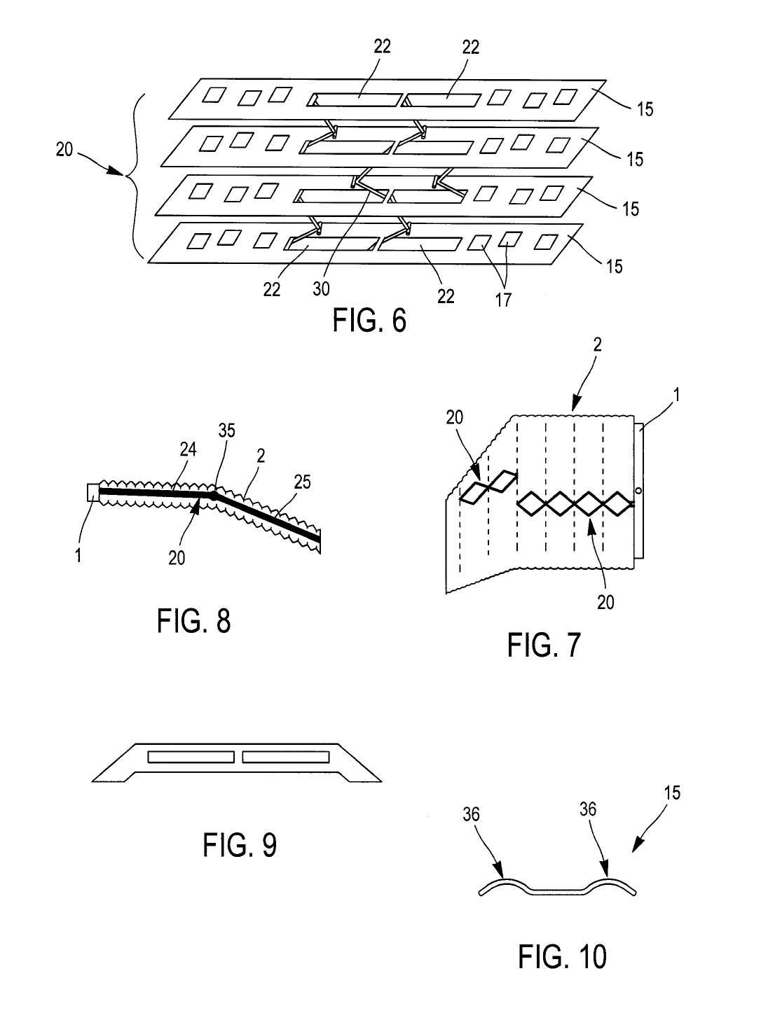

According to the example illustrated and described above, the articulated frame 20 passes inside the rigid ribs 15 without being articulated directly thereon. However, as shown by FIG. 6, the articulated frame may comprise segments 30 directly articulated on the rigid ribs 15, which then form an integral part of the articulated frame 20.

Moreover, according to the invention, the structure of the articulated frame can be implemented in various ways and does not necessarily comprise arms articulated on two segments as described previously. Thus the articulated frame may comprise a pantograph system as illustrated in FIG. 7. It should be noted that, according to this example, the curtain 2 is suitable for being deployed on a substantially horizontal path whereas, according to the example described in relation to FIGS. 1 to 5, the movement of the curtain takes place in a substantially vertical direction. In addition, according to the example in FIG. 7, the curtain has a roughly trapezoidal shape particularly suited to a side window of a vehicle.

FIG. 8 illustrates another variant embodiment according to which the articulated segments 24 and 25 of the articulated frame 20 comprise conical articulations 35 enabling the curtain 2 of the blackout device according to the invention to form an angle when it is in the blackout position as shown.

According to the example embodiment illustrated in FIGS. 1 to 5 and described previously, each rigid rib has, in plan view, a substantially rectangular shape. However, such a shape is not strictly necessary. This is because each rigid rib 15 may have a different shape so as to follow the shape of the glazed opening that the curtain 2 is to black out. Thus FIG. 9 shows an example of a rigid rib, the shape of which is suited to the blackout of a concave glazed opening such as for example a vehicle windscreen.

FIG. 10 illustrates another variant embodiment of a rigid rib of a blackout device according to the invention. According to this variant the rigid rib has, in cross-section, concave and convex metal parts 36. These lateral parts 36 make it possible to guide the folds of the rear 10 and front 11 panels when the inflatable element 3 is deflated. Thus it is possible to fold a greater length of panel than what would be possible to fold if the rib were flat.

According to the example embodiment illustrated in FIGS. 1, 2 and 5, the lateral 12 and bottom 13 panels of the envelope constituting the inflatable element 3 are connected to the ribs 15 and to the load bar 21. However, the lateral and bottom panels could be not connected to the ribs or to the load bar so as to freely inflate in order for example to come into abutment against another adjacent curtain or against the bearing structure of the opening in order to provide better blackout.

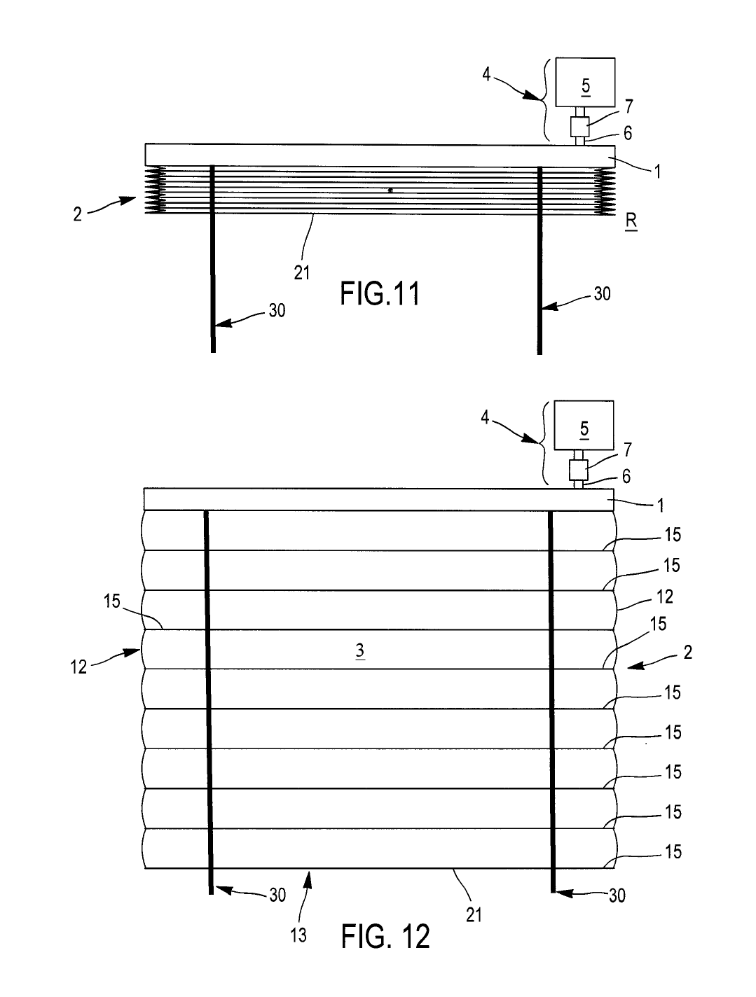

According to the examples described in relation to FIGS. 1 to 7, the guidance mechanism includes the articulated frame 20. However, such an embodiment of the guidance mechanism is not strictly necessary. Thus FIGS. 11 and 12 illustrate another embodiment of the invention according to which the guidance mechanism includes two fixed guide bars 30 that are parallel to each other and to the direction of translation of the load bar 21. The fixed guide bars 30 are at least partly disposed inside the inflatable element 3 constituting the curtain 2 and pass through the load bar 21 and the ribs 15. There therefore exist leaks at each passage of a guide bar 30 in the load bar 21. The flow rate of the inflator 4 is then adapted to compensate for these leaks and to allow inflation of the curtain 2.

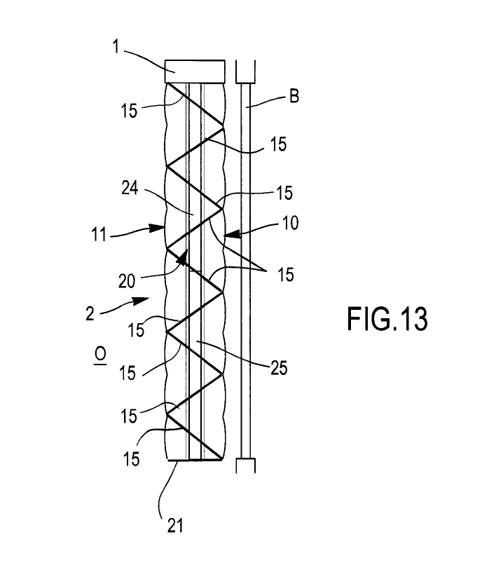

FIG. 13 illustrates yet another embodiment of a curtain according to the invention, according to which the ribs 15 are articulated one after the other in a concertina.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A device for blacking out a glazed opening (B) comprising a chassis supporting a curtain that is able to move between a retraction position (R) and a blackout position (O) and which comprises at least one inflatable element integrated in the curtain and suitable, when it is inflated, for moving the curtain into the blackout position (O) and, when it is deflated, moving the movable curtain into the retracted position (R):
the inflatable element includes a flexible hollow envelope having:
a rear panel intended to be placed close to the glazed opening (B),
a front panel situated opposite to the rear panel and intended to be placed opposite the glazed opening (B),
a load bar is connected to the front and rear panels of the inflatable element, and
a translational guidance mechanism of the load bar is moved in translation by the inflatable element between:
a folded position in which the curtain is folded in the retracted position (R), the load bar being close to the chassis, and
an unfolded position in which the curtain in unfolded in the blackout position (O), the load bar being distant from the chassis.

2. The blackout device as set forth in claim 1, further including at least one rigid rib that is connected to the front and/or rear panels of the inflatable element.

3. The blackout device as set forth in claim 2, further including a plurality of rigid ribs that are each connected to the front and/or rear panels of the inflatable element and are distant from one another when the curtain is in the blackout position (O).

4. The blackout device as set forth in claim 2, wherein each rigid rib is situated inside the envelope of the inflatable element.

5. The blackout device as set forth in claim 4, wherein at least some rigid ribs include openings for the inflation air to pass.

6. The blackout device as set forth in claim 4, wherein some rigid ribs have in cross-section a shape at least partly convex and/or concave.

7. The blackout device as set forth in claim 1, wherein the inflatable element extends over the entire surface of the curtain.

8. The blackout device as set forth in claim 1, wherein the guidance mechanism includes at least one fixed bar for guiding the load bar.

9. The blackout device as set forth in claim 8, wherein the fixed guidance bar extends at least partly inside the inflatable element.

10. The blackout device as set forth in claim 1, wherein the guidance mechanism includes an articulated frame that is connected to the chassis, that carries, opposite to the chassis, a load bar connected to the curtain, and which is able to move between:
a folded position in which the curtain is in the retracted position (R), the load bar being close to the chassis, and
an unfolded position in which the curtain is in the blackout position (O), the load bar being distant from the chassis.

11. The blackout device as set forth in claim 10, wherein the articulated frame is situated inside the envelope of the inflatable element.

12. The blackout device as set forth in claim 2, wherein each rigid rib comprises at least one aperture for the articulated frame to pass.

13. The blackout device as set forth in claim 2, wherein the articulated frame is articulated on at least some of the rigid ribs.

14. The blackout device as set forth in claim 2, wherein the articulated frame is at least partly formed by rigid ribs.

15. The blackout device as set forth in claim 1, further including a motorised inflator suitable for inflating and deflating the inflatable element.
